(19) United States
(12) Patent Application Publication
(10) Pub. No.: US 2025/0159634 A1
(43) Pub. Date: May 15, 2025

(54) Methods For Dual TCI State Switch

(71) Applicant: Nokia Technologies Oy, Espoo (FI)

(72) Inventors: Riikka Karoliina DIMNIK, Espoo (FI); Rafael CAUDURO DIAS DE PAIVA, Aalborg (DK)

(21) Appl. No.: 18/909,163

(22) Filed: Oct. 8, 2024

Related U.S. Application Data
(60) Provisional application No. 63/598,291, filed on Nov. 13, 2023.

(51) Int. Cl. H04W 56/00; H04L 5/00

(52) U.S. Cl. CPC H04W 56/0045; H04L 5/0048

(57) ABSTRACT

A method includes: receiving one or more medium-access-control control-elements for one or more transmission configuration indicator state activations, wherein synchronization signal blocks of associated transmission configuration indicator states are overlapping or adjacent, and wherein the transmission configuration indicator states are activated with the one or more medium-access-control control-elements; and determining in which order the individual transmission configuration indicators states are activated.

### CROSS-REFERENCE TO RELATED APPLICATION

This application is related to and claims the priority of U.S. Provisional Patent Application No. 63/598,291, filed Nov. 13, 2023, the entirety of which is hereby incorporated herein by reference.

### TECHNICAL FIELD

The examples and non-limiting example embodiments relate generally to communications and, more particularly, to methods for dual TCI state switch.

### BACKGROUND

It is known for a communication device to gain access to a network via a cell covered with a transmission reception point in a communication network.

### SUMMARY

Example embodiments of the present disclosure can thus provide apparatuses, methods, computer programs, computer program products, or computer readable media for improving various aspects of mobility measurements. Any example embodiment may be combined with one or more other example embodiments. These and other aspects of the present disclosure will be apparent from the example embodiment(s) described below. According to some aspects, there is provided the subject matter of the independent claims. Some further aspects are defined in the dependent claims.

In some aspects, the techniques described herein relate to an apparatus including: at least one processor; and at least one memory storing instructions that, when executed by the at least one processor, cause the apparatus at least to: receive one or more medium-access-control control-elements for one or more transmission configuration indicator state activations, wherein synchronization signal blocks of associated transmission configuration indicator states are overlapping or adjacent, and wherein the transmission configuration indicator states are activated with the one or more medium-access-control control-elements; and determine in which order the individual transmission configuration indicators states are activated.

In some aspects, the techniques described herein relate to an apparatus including: at least one processor; and at least one memory storing instructions that, when executed by the at least one processor, cause the apparatus at least to: transmit, to a user equipment, one or more medium-access-control control-elements for one or more transmission configuration indicator state activations, wherein synchronization signal blocks of associated transmission configuration indicator states are overlapping or adjacent, and wherein the transmission configuration indicators states are activated with the one or more medium-access-control control-elements; and determine in which order the individual transmission configuration indicator states are activated.

In some aspects, the techniques described herein relate to a method including: receiving one or more medium-access-control control-elements for one or more transmission configuration indicator state activations, wherein synchronization signal blocks of associated transmission configuration indicator states are overlapping or adjacent, and wherein the transmission configuration indicator states are activated with the one or more medium-access-control control-elements; and determining in which order the individual transmission configuration indicators states are activated.

In some aspects, the techniques described herein relate to a method including: transmitting, to a user equipment, one or more medium-access-control control-elements for one or more transmission configuration indicator state activations, wherein synchronization signal blocks of associated transmission configuration indicator states are overlapping or adjacent, and wherein the transmission configuration indicators states are activated with the one or more medium-access-control control-elements; and determining in which order the individual transmission configuration indicator states are activated.

Other example embodiments are provided or described for each of the example methods, including: means for performing any of the example methods; a non-transitory computer-readable storage medium comprising instructions stored thereon that, when executed by at least one processor, are configured to cause an apparatus to perform any of the example methods; and an apparatus including at least one processor, and at least one memory including computer program code, the at least one memory and the computer program code configured to, with the at least one processor, cause the apparatus at least to perform any of the example methods.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 depicts a single-DCI mode.

FIG. 3 depicts a multi-DCI mode.

FIG. 4 depicts MAC-CE based TCI state switching delay in single-DCI mode, and overlapping SSBs.

FIG. 5 depicts MAC-CE based TCI state switching delay in multi-DCI mode with overlapping SSBs.

FIG. 6 depicts Option 1 in the s-DCI scenario, where the UE synchronizes first with the first SSB that has longer SSB periodicity.

FIG. 7 depicts Option 2 in the s-DCI scenario, where the UE synchronizes first with the SSB that comes first in time domain.

FIG. 8 depicts Option 1 for the m-DCI scenario, where the UE synchronizes first with the SSB with the longer SSB periodicity.

FIG. 9 depicts Option 2 for the m-DCI scenario, where the UE synchronizes first with the SSB that comes first in time after decoding the MAC-CE.

FIG. 10 depicts TCI activation of one known and one unknown TCI state.

FIG. 11 depicts TCI activation of two unknown TCI states, and different SSB periodicity.

FIG. 12 is an example apparatus configured to implement the examples described herein.

FIG. 13 shows a representation of an example of non-volatile memory media used to store instructions that implement the examples described herein.

FIG. 14 is an example method, based on the examples described herein.

FIG. 15 is an example method, based on the examples described herein.

### DETAILED DESCRIPTION OF EXAMPLE EMBODIMENTS

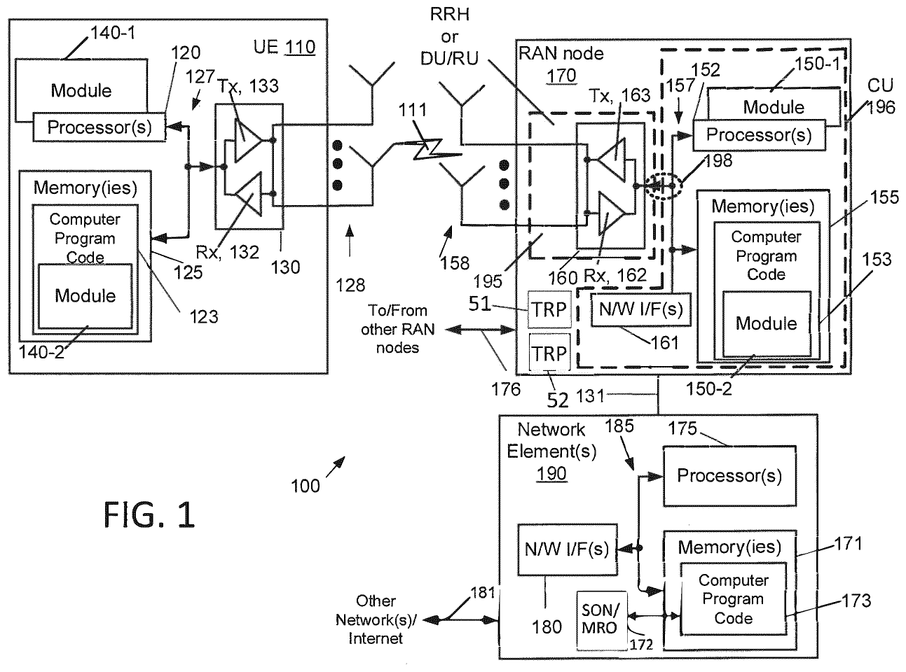

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Multi-TRP (transmission point) transmission and reception can be implemented using two different modes of operation: single-DCI and multi-DCI. In the 3GPP work item for MIMO evolution for downlink and uplink, unified TCI states are used to provide QCL relationship to reference signals for the uplink and downlink of each TRP link.

The unified TCI state framework was specified by 3GPP in Rel-17. In Rel-15/16, TCI states were only configured for downlink, while uplink spatial relation covered the beam indication for uplink. With the unified TCI state concept, TCI states are configured for both downlink and uplink. The configuration is either joint, where same TCI state covers both UL and DL, or separate, where separate TCI states are configured for DL and UL.

Unified TCI state framework uses a common TCI state concept, where one common TCI/indicated TCI state at a time provides spatial assumption for the set of signals and channels (PDCCH, PDSCH, PUCCH, PUSCH, CSI-RS, SRS).

Assigning the unified TCI states is done with the following steps (1-3):
1. RRC-based configuration of up to 128 TCI states;
2. MAC-CE-based activation of TCI states into up to 8 codepoints in active TCI state list. If only one TCI state is activated to the active TCI state list, this also becomes the indicated TCI state;
3. DCI-based indication of a single joint TCI state or TCI state pair of DL and UL TCI states. This step is only needed if there are more than one TCI state on the active TCI state list.

In the Rel-18 work item for MIMO evolution for downlink and uplink, unified TCI states are used in single-DCI and multi-DCI mode as described in the following.

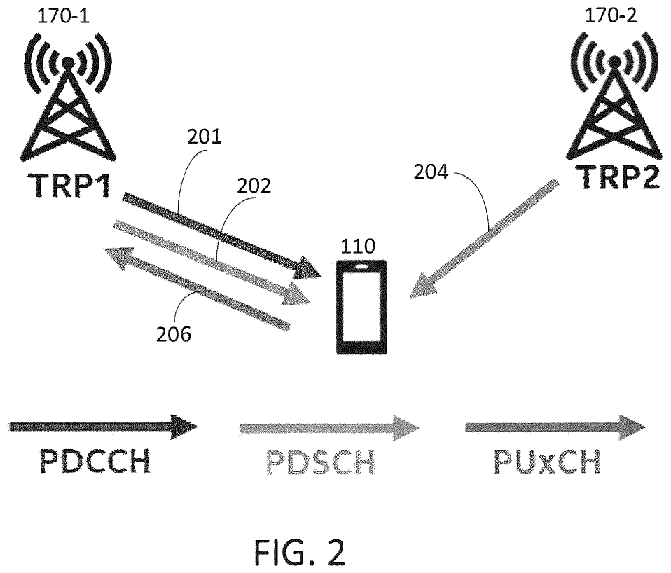

FIG. 2 depicts single-DCI, where PDCSH (202, 204) is scheduled from two TRPs (170-1, 170-2) by a single DCI on PDCCH 201, which is only scheduled from one (170-1) of the TRPs. Uplink transmission 206 can be configured for one of the links or in newer releases for both links.

In single-DCI mode, when unified TCI states are used, the UE 110 is configured with a set of joint DL/UL TCI states and/or separate DL and UL TCI states. In the work item for MIMO evolution for downlink and uplink, a single MAC-CE command has been defined to activate either one or two joint DL/UL TCI states (or separate DL/UL TCI states) in max 8 codepoints to the UE's active TCI state list. A single DCI is used to indicate one of the codepoints comprising one or two TCI states with different QCL Type D sources to each TRP link. An example with joint DL/UL TCI states is shown in Table 1.

TABLE 1
Active TCI state list for s-DCI

| | Joint DL/UL | Joint DL/UL |
|---|---|---|
| | TCI state for | TCI state for |
| Codepoint# | TRP1 | TRP2 |
| 0 | TCI#0 | TCI#5 |
| 1 | TCI#0 | TCI#6 |
| 2 | TCI#1 | TCI#5 |
| 3 | TCI#2 | TCI#5 |
| 4 | TCI#3 | TCI#6 |
| 5 | TCI#3 | TCI#7 |
| 6 | TCI#0 | |
| 7 | TCI#1 | |

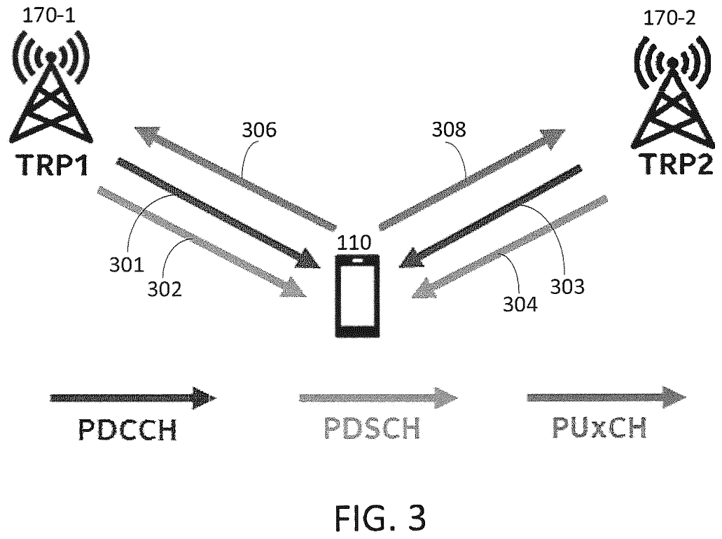

FIG. 3 depicts multi-DCI, where PDSCH (302, 304) is scheduled with own DCIs on PDCCH (301, 303) that is scheduled from each TRP (170-1, 170-2). Uplink transmission (306, 308) may be scheduled for both TRP links.

In multi-DCI mode, when unified TCI states are used, similar to single-DCI mode, the UE 110 is configured with a set of joint DL/UL TCI states and/or separate DL and UL TCI states. Different from single-DCI mode, in multi-DCI mode, separate MAC-CE commands are used for each TRP link to activate up to 8 joint DL/UL TCI states (or separate DL/UL TCI states) into max 8 codepoints to separate active TCI state lists for each TRP. Separate DCIs transmitted from each TRP are used to indicate one of the codepoints from each of the TRP specific active TCI state list. An example with joint DL/UL TCI states is shown in Table 2.

TABLE 2
Active TCI state lists for multi-DCI

| | |
|---|---|
| | Joint DL/UL |
| Codepoint# | TCI state |

Active TCI state list for TRP1

| | |
|---|---|
| 0 | TCI#0 |
| 1 | TCI#1 |
| 2 | TCI#2 |
| 3 | TCI#3 |
| 4 | TCI#4 |
| 5 | TCI#5 |
| 6 | TCI#6 |
| 7 | TCI#7 |

Active TCI state list for TRP2

| | |
|---|---|
| 0 | TCI#8 |
| 1 | TCI#9 |
| 2 | TCI#10 |
| 3 | TCI#11 |
| 4 | TCI#12 |
| 5 | TCI#13 |
| 6 | TCI#14 |
| 7 | TCI#15 |

RAN4 has defined TCI state switching delay requirements for unified TCI states for Rel-17 in TS 38.133 section 8.15 for downlink and section 8.16 for uplink. The requirements define the delay within which the UE shall be able to complete the switching and receive and/or transmit data using the target TCI state.

MAC-CE based TCI state activation is defined in sections 8.15.3 and 8.15.5 for DL and sections 8.16.3 and 8.16.5 for uplink.

MAC-CE based TCI state activation is performed after receiving MAC-CE command to activate one or more TCI states to the active TCI state list. During the MAC-CE activation delay, the UE will perform fine time/frequency tracking using the first SSB with the correct QCL relationship after the UE has processed the MAC-CE command. When the target TCI state is known, for DL TCI state, the UE shall be able to receive using the target TCI state after the predefined switching delay requirement. When the target TCI state is unknown, an additional L1-RSRP measurement period is added in the delay. TCI state is known under various conditions.

DCI-based TCI state indication is described in TS 38.133 Section 8.15.4 for DL and section 8.16.4 for uplink, where the indicated TCI state shall be applied after delay beamApplicationTime from the time the UE has sent a HARQ-ACK response to the DCI that is indicating a TCI state in the codepoint of the UE's active TCI state list.

The examples described herein are directed to MAC-CE based TCI state activation/indication/switching.

In the work item for MIMO evolution for downlink and uplink, 3GPP RAN4 is defining TCI state switching requirements for switching of two TCI states with different QCL Type D sources with a single MAC-CE command in single-DCI mode and with two separate MAC-CEs in multi-DCI mode.

RAN4 has agreed to define the requirements in Rel-18 under the assumption that the UE is not capable of simultaneous downlink reception or uplink transmission.

When two downlink TCI states are switched in single-DCI mode with one MAC-CE, two first SSBs are included in the requirement. Also, when both or one of the target TCI states are unknown, L1-RSRP measurement period is added in the delay for the unknown TCI state(s).

When the SSBs which are used for fine time/frequency tracking for the two activated downlink TCI states are i) overlapping (completely or partially in time domain), or ii) adjacent, the UE is not expected to be able to do the T/F tracking for both of the first SSBs right after processing the MAC-CE, but the UE may need an additional SSB periodicity to be able to synchronize with both SSBs. This is because the UE may be receiving the two SSBs from different directions with different panels, and when the UE is not capable of simultaneous reception with two panels, the UE would need to switch the panel to be able to synchronize with both SSBs. When the SSBs are overlapping or adjacent to each other, the UE would not have time to switch the panel so fast that it would be able to measure both SSBs on the first occasion (overlapping or adjacent).

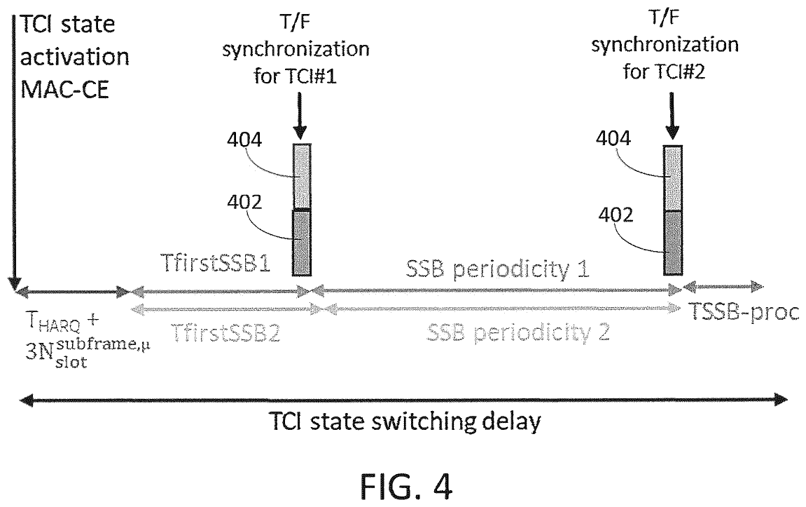

This is illustrated in FIG. 4, where the UE is switching to TCI state #1 and #2. The UE synchronizes first with SSB1 402 with QCL relationship to TCI state #1 but is not able to measure SSB2 404 which is overlapping with SSB1 402 in the first occasion and has to therefore wait for a whole SSB period to be able to synchronize with SSB2 404 which has a QCL relationship to TCI state #2. Accordingly, FIG. 4 shows MAC-CE based TCI state switching delay in a single-DCI mode with overlapping SSBs (402, 404).

The UE is not expected to receive or transmit using the target TCI state before the TCI state switch is completed, and hence the network should not schedule the UE during this time. When two TCI states are switched simultaneously, two options are possible (Behavior 1 and Behavior 2):

Behavior 1: Individual delays are considered for scheduling from each TRP, i.e. the UE can start to receive/transmit with TCI state #1 (as in FIG. 4) once the switch is completed even though TCI state #2 switch is not yet complete. The UE can receive/transmit both TCI states when both switches have been completed.

Behavior 2: Total delay is considered for scheduling from each TRP, i.e. the UE cannot receive or transmit on any of the TCI states until both TCI state switches are completed. UE can receive with both TCI states once both switches have been completed.

When Behavior 1 is considered, the problem is that if the SSBs are overlapping or adjacent, the network does not know which SSB the UE prioritizes on the first occasion i.e. which TCI state switch will be completed first. Therefore, the network has to assume an additional SSB periodicity for both TCI state switching delays and it cannot start scheduling TCI state #1 as in FIG. 4 before both TCI state switches are completed. This means that Behavior 1 actually becomes Behavior 2.

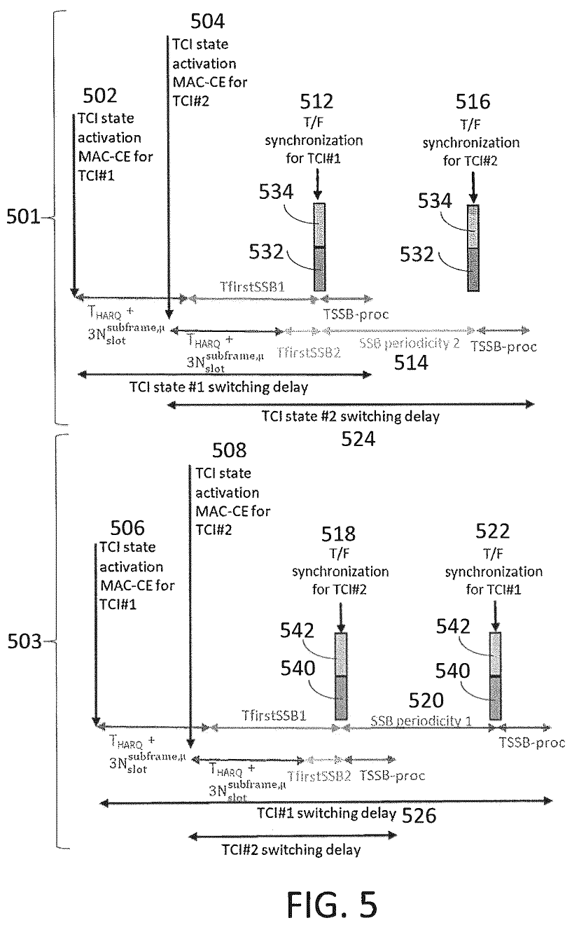

This problem is illustrated for the multi-DCI case in FIG. 5, where TCI state #1 is activated for TRP1 with one MAC-CE (502, 506), and shortly after this TCI state #2 is activated for TRP #2 with another MAC-CE (504, 508). MAC-CEs may also be received simultaneously in time domain. Two UE behaviors are shown when the first SSBs associated to the activated TCI states after decoding the MAC-CEs are overlapping with each other in time domain (1-2):

1. In the upper FIG. 501), the UE 110 first synchronizes with SSB1 532 and completes the TCI state activation for TCI state #1 (512). Because the UE was not able to synchronize with SSB2 534 on the first occasion, the UE needs to wait for a second occasion of the SSB2 534, resulting in an additional delay equal to the SSB periodicity for SSB2 (514) to be able to complete the TCI state activation for TCI state #2 (516).

2. In the lower FIG. 503) the UE 110 first synchronizes with SSB2 542 and completes TCI state #2 activation (518) first. An additional SSB periodicity (520) for SSB1 540 is needed for the UE to be able to complete activation of TCI state #1 (522).

Since the network does not know which SSB the UE synchronizes with first, the network must assume a longer TCI state switching delay of one SSB periodicity for both TCI state switches (i.e. TCI #2 switching delay (524) in the upper FIG. 501) and TCI #1 switching delay (526) in the lower figure (503)). Hence, the network cannot schedule the UE 110 on either of the TCI states before this longer delay.

Accordingly, FIG. 5 shows MAC-CE based TCI state switching delay in multi-DCI mode with different SSB periodicities, with overlapping SSBs.

Additionally, in some cases, the SSBs may be overlapping or adjacent on some occasions, but the SSB periodicity between the two SSBs is different e.g. 20 ms for one and 160 ms for the other. In this example, if the UE synchronizes first with the SSB that has 20 ms periodicity, then it has to wait for 160 ms to synchronize with the other one.

Hence, another problem is, how to minimize the interruption in scheduling when the SSBs are overlapping or adjacent in time either in all or in some occasions.

In multi-DCI scenario, the two (or more) TCI states per TRP are activated with separate MAC-CEs and the TCI state switches are independent. It has not been defined how the delay is defined in this case, when the first SSBs for activated TCI states are overlapping or adjacent.

When two TCI states with different QCL Type D sources are activated either with one MAC-CE (in s-DCI case) or two MAC-CEs (in m-DCI case), and the SSBs associated to the TCI states are overlapping or adjacent, the examples described herein define the MAC-CE based TCI state switching delay requirement based on one or more of the following behaviors, to make it clear to the network when the UE shall be ready with each TCI state switch (Option 1, Option 2, Option 3, Option 4, Option 5):

Option 1: When the SSBs are adjacent or overlapping in time, it is chosen by SSB periodicity and the status of the TCI state, which TCI state is activated first. When both TCI states are known, the UE activates first the TCI state associated to the SSB that has the longer SSB periodicity. When both TCI states are unknown, the UE activates first the TCI state associated to the SSB that has the shorter SSB periodicity.

Option 2: When the SSBs are adjacent or overlapping to each other, the UE activates first the TCI state that is associated with the SSB that comes first in time after decoding the MAC-CE.

Option 3: When the SSBs are adjacent or overlapping in time, the UE activates first the TCI state of the anchor link. Note: the anchor link may be defined as one of the following (i-iii): i) The TCI state that comes from the TRP with the PDCCH TCI state, in case PDCCH is transmitted by a single TRP (s-DCI), ii) The TCI state that comes from the TRP with the UL TCI state, in case PUSCH/PUCCH is transmitted to a single TRP, iii) The anchor TRP is configured by the network; or a combination of (i-iii).

Option 4: In m-DCI mode, when the SSBs are adjacent or overlapping in time, the UE activates first the TCI state for which the MAC-CE arrived first in time.

Option 5: When one target TCI state is known and one is unknown, the TCI state switching delay shall be defined so that the UE activates the known TCI state first.

Options 1 through 5 may also be used together.

Activating the TCI state in these options means that after decoding the TCI state activation MAC-CE(s) the UE performs either (i-ii): i) Known TCI state: time/frequency synchronization with first SSB, and SSB processing, or ii) Unknown TCI state: L1-RSRP measurement, time/frequency synchronization with first SSB, and SSB processing.

Doing these steps “first” means that the UE uses the SSB associated to the firstly activated TCI state on the first overlapping or adjacent SSB occasion(s) to complete these steps. Further details are given in the detailed description.

Described herein is how to implement Options 1-5 in s-DCI and m-DCI modes when the two target TCI states are either both known, both unknown or one of them is known and one unknown.

### A. Two Known Target TCI States

### A.1 Single-DCI

The Options applicable to single-DCI mode (1-3) given previously can be implemented in the ways described herein, when both target TCI states are known. First SSBs are overlapping or adjacent to each other.

### Option 1:

UE behavior: To minimize the total TCI state switching delay of the two TCI states the UE follows the 3 steps below (1-3):

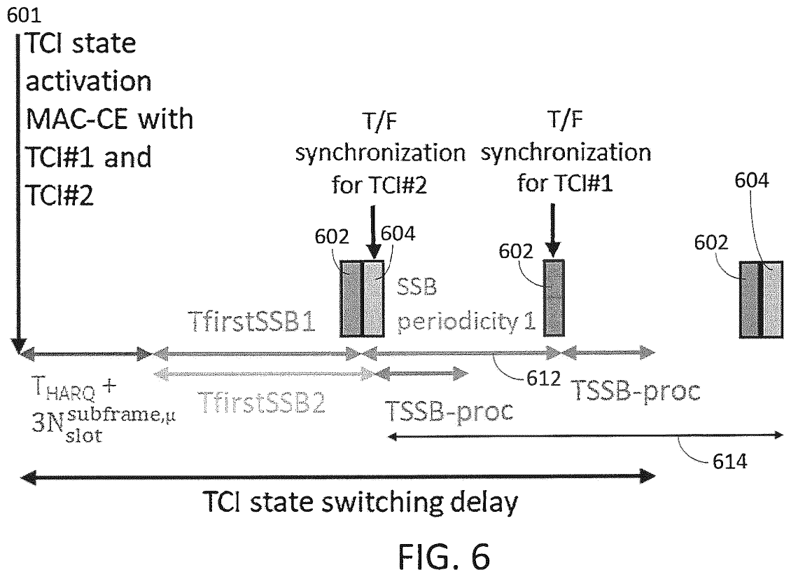

1. The UE shall first synchronize with the first SSB that has a longer SSB periodicity. The UE does this independent of which of the two adjacent SSBs is first in time (e.g. in FIG. 6 this is SSB2 604 even though it comes later in time than SSB1 602).

2. The UE shall synchronize with the SSB with the shorter SSB periodicity on the second SSB occasion after decoding the MAC-CE 601.

3. TCI state switching delay is defined by adding an additional SSB periodicity of the SSB that has the shorter periodicity in the delay requirement.

Thus, FIG. 6 shows Option 1 in the s-DCI scenario, where the UE synchronizes first with the first SSB 604 that has longer SSB periodicity. The periodicity of SSB1 602 is given as periodicity 612 and the periodicity of SSB2 604 is given as periodicity 614.

The TCI state switching delay requirement would be written for the s-DCI case in the following way for Option 1: When the first SSBs associated with the two downlink TCI states being activated with the same MAC-CE command are overlapping or adjacent to each other, and neither of these two downlink TCI states is on the active TCI state list, the UE shall be able to receive UE-dedicated PDCCH/PDSCH at the first slot that is after slot T_{HARQ}+3Nₛₗₒₜ^{subframe,μ}+(T_{first-SSB1}+T_{SSB-proc}+T_{SSB1})/NR slot length, where Nₛₗₒₜ^{subframe,μ} is the number of slots per subframe for numerology μ, T_{HARQ} (in slot) is the timing between DL data transmission and acknowledgement, and where (1-4):

1. T_{first-SSB} is time to first SSB transmission after MAC CE command is decoded by the UE; The SSB shall be the QCL-TypeA or QCL-TypeC to target TCI state.

2. T_{SSB-proc}=2 ms.

3. T_{SSB1} and T_{SSB2} are the SSB periodicities of the SSBs (i.e., SSB1 and SSB2) associated to the two activated TCI states, respectively, and SSB1 denotes the SSB that is synchronized after the other SSB because T_{SSB1}≤T_{SSB2}.

4. The first SSB1 and first SSB2 are overlapping, or adjacent.

### Option 2:

### UE Behavior:

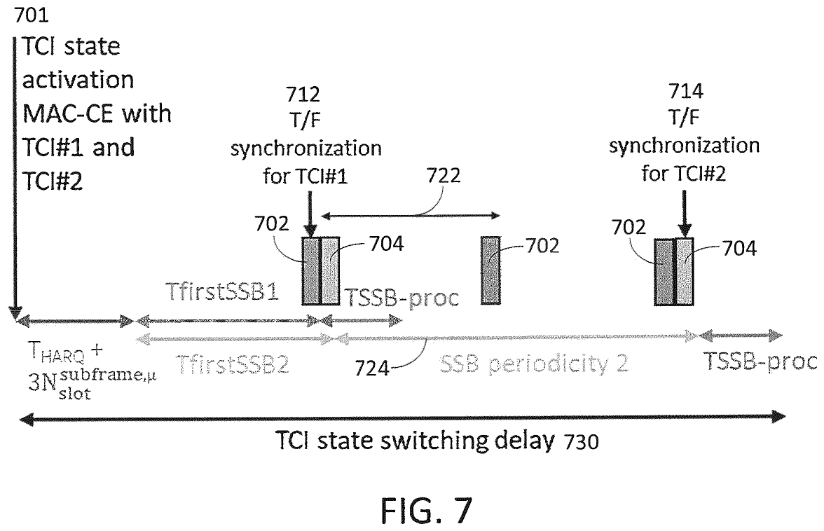

Referring to FIG. 7, the UE shall first synchronize with the SSB that comes first in time after decoding the TCI state activation MAC-CE 701, no matter what is the SSB periodicity or which link this SSB is associated with. Thus as shown in FIG. 7, the UE synchronizes (712) with SSB1 702 before synchronizing (714) with SSB2 704, where SSB1 702 comes in time before SSB2 704, even though SSB2 704 has a longer periodicity 724 than the periodicity 722 of SSB1 702.

TCI state switching delay 730 is defined by adding an additional SSB periodicity for the SSB that comes second in time.

Thus, FIG. 7 shows Option 2 in the s-DCI scenario, where the UE synchronizes first with the SSB that comes first in time domain.

The TCI state switching delay requirement may be written for the s-DCI case in the following way for Option 2:

When the first SSBs associated with the two downlink TCI states being activated with the same MAC-CE command are overlapping or adjacent to each other, the UE shall be able to receive UE-dedicated PDCCH/PDSCH at the first slot that is after slot T_{HARQ}+3Nₛₗₒₜ^{subframe,μ}+(max {TOₖ₁*(T_{first-SSB1}+T_{SSB-proc}), TOₖ₂*(T_{first-SSB2}+T_{SSB-proc})}+Toverlap*T_{SSB_later})/NR slot length, where (1-6):

1. T_{first-SSB} is time to first SSB transmission after MAC CE command is decoded by the UE; The SSB shall be the QCL-TypeA or QCL-TypeC to target TCI state

2. T_{SSB-proc}=2 ms

3. TOₖ₁=1 if the first target TCI state is not in the active TCI state list for PDSCH/PDCCH, 0 otherwise.

4. TOₖ₂=1 if the second target TCI state is not in the active TCI state list for PDSCH/PDCCH, 0 otherwise.

5. T_{SSB_later} is the SSB periodicity of the SSB transmission SSB1 or SSB2, which comes second in time after MAC CE command is decoded by the UE.

6. Toverlap=1 if TOₖ₁=TOₖ₂=1 and the first SSB1 and first SSB2 are overlapping or adjacent.

### Option 3:

UE behavior: To enable shorter interruption in scheduling the anchor link: The UE shall first synchronize with the SSB associated to the target TCI state for the anchor link (as defined previously), TCI state switching delay is defined by adding an additional SSB periodicity for the SSB associated to the TCI state of the other link.

The TCI state switching delay requirement would be written for the s-DCI case in the following way for Option 3: When the first SSBs associated with the two downlink TCI states being activated with the same MAC-CE command are overlapping or adjacent to each other, and neither of these two downlink TCI states is on the active TCI state list, the UE shall be able to receive UE-dedicated PDCCH/PDSCH at the first slot that is after slot T_{HARQ}+3Nₛₗₒₜ^{subframe,μ}+(T_{first-SSB_non-anchor}+T_{SSB-proc}+T_{SSB_non-anchor})/NR slot length, where (1-4): slot

1. T_{first-SSB} is time to first SSB transmission after MAC CE command is decoded by the UE; The SSB shall be the QCL-TypeA or QCL-TypeC to target TCI state

2. T_{SSB-proc}=2 ms

3. T_{SSB_non-anchor} is the SSB periodicity of the first SSB transmission SSB₁ or SSB₂, which is associated to the target TCI state that is activated for the non-anchor link.

4. The first SSB1 and first SSB2 are overlapping, or adjacent.

In any of the options 1-3 for s-DCI, both of the solutions discussed in RAN4 can be supported (Behavior 1 and Behavior 2):

Behavior 1: The UE can be scheduled independently from each TCI state when independent TCI state switch is completed. The UE can be scheduled from both TCI states when the activation of both TCI states is completed. Here, when it is clearly defined in the standard which TCI state switch is to be completed first as in Options 1-3, the network knows which TCI state it can start scheduling independently before dual TCI state switch is completed. For this case, Option 3 may be beneficial for the s-DCI case as the UE can start receiving PDCCH and transmitting in UL on the anchor link with the shortest possible delay. Scheduling from two TRPs follows after the second TCI state switch is completed as well. The benefit of Option 1 is that if scheduling from two TRPs and a short total TCI state switching delay of the two TCI states is preferred, the UE has a shorter interruption to the multi-TRP operation when the total TCI state switching delay of the two TCI states is shorter. The benefit of Option 2 is that the network knows which TCI state switch is completed first and it can start scheduling that TCI state earlier. Some UEs may prefer this behavior due to implementation reasons.

Behavior 2: The UE cannot be scheduled from independent TCI states before both TCI state switches have been completed. The UE can be scheduled from both TCI states when the activation of both TCI states is completed. Here the benefit of Option 1 is that the UE can complete the dual TCI state switch in the shortest possible time. In other options, the delay may be longer if the SSB with which the UE synchronizes second has the longest SSB periodicity.

### A.2 Multi-DCI

The Options 1-4 given previously can be implemented in as described herein.

### Option 1:

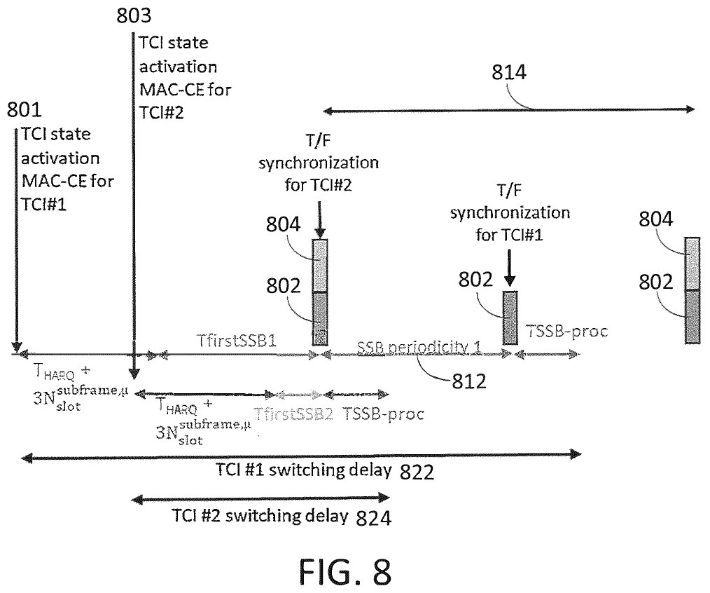

Referring to FIG. 8, to minimize the total TCI state switching delay of the two TCI states (1-3):

1. The UE completes the TCI state switch for the TCI state that is associated to SSB with the longest SSB periodicity first i.e. synchronizes with the first SSB after decoding MAC-CE as done with SSB 804 of TCI state #2 in FIG. 8.

2. The UE completes the TCI state switch for the TCI state that is associated to the SSB with the shortest SSB periodicity (in FIG. 8, SSB 802) based on the second SSB after decoding the MAC-CE i.e. one additional SSB periodicity is allowed in the TCI state switching delay (as done with TCI state #1 in FIG. 8). In FIG. 8, SSB 802 has periodicity 812, and SSB 804 has periodicity 814.

3. The above steps are done in the given order independent of which SSB comes first in time after decoding the MAC-CEs (801, 803) and independent of which MAC-CE arrives first at the UE.

Thus, FIG. 8 shows Option 1 for the m-DCI scenario, where the UE synchronizes first with the SSB (804) with the longer SSB periodicity. FIG. 8 shows TCI #1 switching delay 822 and TCI #2 switching delay 824.

The TCI state switching delay requirement for Option 1 may be written for the multi-DCI case in the following way for each MAC-CE/target TCI state: When a MAC CE command indicating a downlink TCI state switch for CORESETPoolIndex p is received at slot n, and if the TCI state is known, UE shall be able to receive on the target TCI state at the first slot that is after slot n+T_{HARQ}+3Nₛₗₒₜ^{subframe,μ}+TOₖ*(T_{first-SSBp},+T_{SSB-proc}+X*T_{SSBp})/NR slot length, where (1-6):

1. T_{first-SSBp} is time to first SSB transmission (i.e., SSB associated to CORESETPoolIndex p) after MAC CE command is decoded by the UE; The SSB shall be the QCL-TypeA or QCL-TypeC to target TCI state.

2. T_{SSB-proc}=2 ms

3. TOₖ=1 if target TCI state is not in the active TCI state list for PDSCH/PDCCH, 0 otherwise.

4. T_{SSBp} is the SSB periodicity.

5. X=1, when the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, and the first SSB transmissionSSBₚ for the TCI state activated for CORESETPoolIndex p overlaps or is adjacent to the first SSB transmission SSB_{q} for the TCI state activated for CORESETPoolIndex q after decoding the MAC-CEs, and if T_{OK}=1 for both target TCI states, and if T_{SSBp}<T_{SSBq}, or if T_{SSBp}=T_{SSBq} and UE synchronizes with SSB_{q} before SSBₚ; otherwise X=0.

6. The first SSBₚ and first SSB_{q} are considered overlapping or adjacent.

### Option 2:

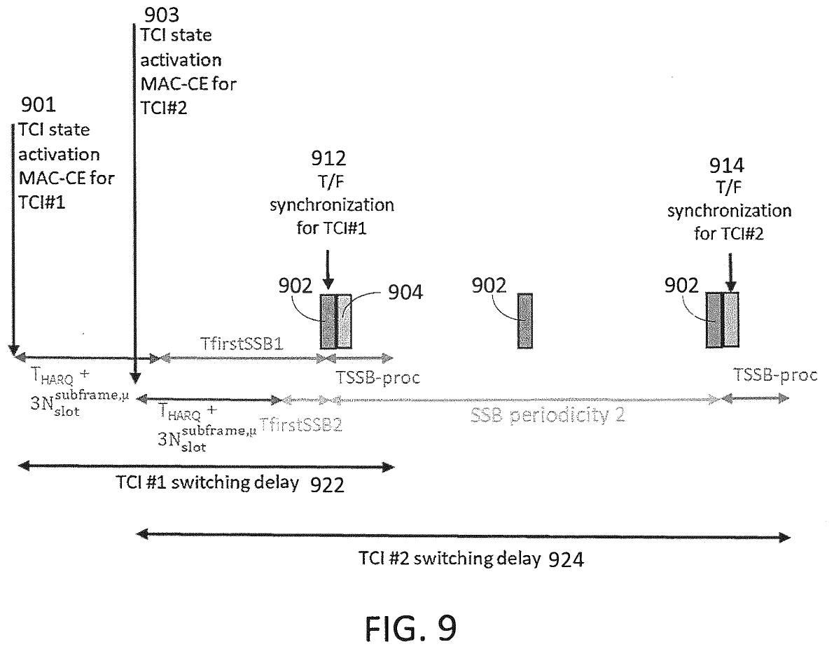

Referring to FIG. 9, the UE completes the TCI state switch for the TCI state that is associated to SSB that comes first in time after decoding the MAC-CEs (901, 903).

For the other TCI state, the UE shall synchronize with the second SSB after decoding the MAC-CE and one additional SSB periodicity is allowed in the TCI state switching delay.

Thus, FIG. 9 shows option 2 for the m-DCI scenario. The UE synchronizes first with the SSB that comes first in time after decoding the MAC-CE. In FIG. 9, SSB 902 comes first in time before SSB 904, thus synchronization for TCI #1 (912) is performed before synchronization for TCI #2 (914). FIG. 9 shows TCI #1 switching delay 922 and TCI #2 switching delay 924.

The TCI state switching delay requirement for Option 2 may be written for the multi-DCI case in the following way for each MAC-CE/target TCI state: When a MAC CE command indicating a downlink TCI state switch for CORESETPoolIndex p is received at slot n, and if the TCI state is known, UE shall be able to receive on the target TCI state at the first slot that is after slot n+T_{HARQ}+3Nₛₗₒₜ^{subframe,μ}+TOₖ*(T_{first-SSBp}, +T_{SSB-proc}+X*T_{SSBp})/NR slot length, where (1-6):

1. T_{first-SSBp} is time to first SSB transmission (i.e., SSB associated to CORESETPoolIndex p) after MAC CE command is decoded by the UE; The SSB shall be the QCL-TypeA or QCL-TypeC to target TCI state.

2. T_{SSB-proc}=2 ms

3. TOₖ=1 if target TCI state is not in the active TCI state list for PDSCH/PDCCH, 0 otherwise.

4. T_{SSBp} is the SSB periodicity.

5. X=1, when the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, and the first SSB transmission SSBₚ for the TCI state activated for CORESETPoolIndex p is adjacent to first SSB transmission SSB_{q} for the TCI state activated for CORESETPoolIndex q after decoding the MAC-CEs, and if T_{OK}=1 for both target TCI states, and if the first SSBₚ comes later in time than the first SSB_{q}; otherwise, X=0.

6. The first SSBₚ and first SSB_{q} are considered overlapping or adjacent.

### Option 3:

To enable shorter interruption in scheduling the anchor link: The UE shall first synchronize with the SSB associated to the target TCI state for the anchor link, i.e. completes the TCI state for this link first. TCI state switching delay is defined by adding an additional SSB periodicity to the delay for the SSB associated to the TCI state of the other link.

The TCI state switching delay requirement for Option 3 would be written for the multi-DCI case in the following way for each MAC-CE/target TCI state: When a MAC CE command indicating a downlink TCI state switch for CORESETPoolIndex p is received at slot n, and if the TCI state is known, UE shall be able to receive on the target TCI state at the first slot that is after slot n+T_{HARQ}+3Nₛₗₒₜ^{subframe,μ}+TOₖ*(T_{first-SSBp}, +T_{SSB-proc}+X*T_{SSBp})/NR slot length, where (1-6):

1. T_{first-SSBp} is time to first SSB transmission (i.e., SSB associated to CORESETPoolIndex p) after MAC CE command is decoded by the UE; The SSB shall be the QCL-TypeA or QCL-TypeC to target TCI state.

2. T_{SSB-proc}=2 ms

3. TOₖ=1 if target TCI state is not in the active TCI state list for PDSCH/PDCCH, 0 otherwise.

4. T_{SSBp} is the SSB periodicity.

5. X=1, when the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, and the first SSB transmission SSBₚ for the TCI state activated for CORESETPoolIndex p overlaps or is adjacent to first SSB transmission SSB_{q} for the TCI state activated for CORESETPoolIndex q after decoding the MAC-CEs, and if T_{OK}=1 for both target TCI states, and if CORESETPoolIndex p is the CORESETPoolIndex of the non-anchor link; otherwise, X=0.

6. The first SSBₚ and first SSB_{q} are considered overlapping or adjacent.

### Option 4:

The UE completes the TCI state switched in the order of arrival of the TCI state activation MAC-CEs i.e. the UE uses the first SSB occasion for the TCI state activated in the first MAC-CE and the second SSB occasion for the TCI state activated in the second MAC-CE. Additional SSB periodicity is allowed for the delay of the second TCI state switch.

The scenario is similar as the illustration in FIG. 9.

The TCI state switching delay requirement for Option 4 would be written for the multi-DCI case in the following way for each MAC-CE/target TCI state: When a MAC CE command indicating a downlink TCI state switch for CORESETPoolIndex p is received at slot n, and if the TCI state is known, UE shall be able to receive on the target TCI state at the first slot that is after slot n+T_{HARQ}+3Nₛₗₒₜ^{subframe,μ}+TOₖ*(T_{first-SSBp}, +T_{SSB-proc}+X*T_{SSBp})/NR slot length, where (1-6):

1. T_{first-SSBp} is time to first SSB transmission (i.e., SSB associated to CORESETPoolIndex p) after MAC CE command is decoded by the UE; The SSB shall be the QCL-TypeA or QCL-TypeC to target TCI state.

2. T_{SSB-proc}=2 ms

3. TOₖ=1 if target TCI state is not in the active TCI state list for PDSCH/PDCCH, 0 otherwise.

4. T_{SSBp} is the SSB periodicity.

5. X=1, when the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, and the first SSB transmission SSBₚ for the TCI state activated for CORESETPoolIndex p overlaps or is adjacent to first SSB transmission SSB_{q} for the TCI state activated for CORESETPoolIndex q after decoding the MAC-CEs, and if T_{OK}=1 for both target TCI states, and if MAC CE activating SSBₚ comes later in time than MAC CE activating SSB_{q}; otherwise, X=0.

6. The first SSBₚ and first SSB_{q} are considered overlapping or adjacent.

### Further Comments on the Options:

Since RAN4 agreed that the TCI state switches for multi-DCI case are independent to each other, the UE will complete each TCI state switch independently and can be scheduled after the completion of each TCI state switch independently. The UE can be scheduled from both TRPs after both TCI state switches have been completed. Hence, for the multi-DCI scenario, the benefit of all Options 1-4 above is that the network knows which TCI state switch takes longer. Option 1 has additional benefit of minimizing the interruption of multi-TRP operation, since the overall delay of switching both TCI states is shorter. Furthermore, if for some similar case the assumption would be that the UE cannot receive either of the TCI states before both switches are completed, Option 1 would be the most beneficial option.

B. Dual TCI State Switch with One Known and One Unknown TCI State

When one of the TCI states of the two TCI states being activated are unknown, the TCI state switching delay for the unknown TCI state would include also a L1-RSRP measurement period before the synchronization with the “first SSB”.

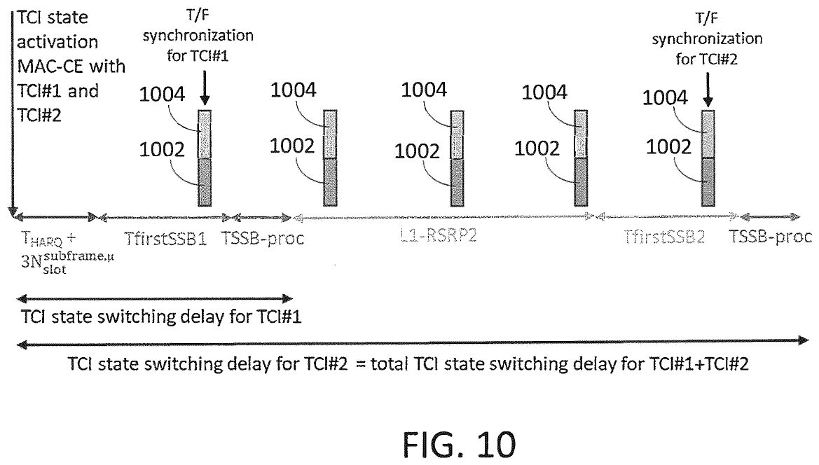

Option 5: Referring to FIG. 10, in the overlapping or adjacent SSB case, if the known TCI state is not on the active TCI state list, the UE shall first complete the TCI state switch of the known TCI state i.e. the order of measurements is: first synchronize with SSB associated to the known TCI state (this TCI state can potentially start to be scheduled after this), and then perform L1-RSRP measurement period starting from the second SSB for the unknown TCI state and synchronize with the SSB associated to this TCI state (after this the UE can be scheduled from both TRPs)

FIG. 10 shows TCI activation of one known and one unknown TCI state. In FIG. 10, SSB 1002 is associated with known state TCI #1, and SSB 1004 is associated with unknown state TCI #2.

Doing the activation of TCI states in this order is beneficial if the UE can start receiving one TCI state when the switch is completed for that TCI state. If the UE can only start receiving both TCI states once both switches are completed, it makes no difference which TCI state is activated first.

Note that here it is assumed that for L1-RSRP measurement, same overlapping SSBs are used. If different reference signals are used (e.g. CSI-RS) for the L1-RSRP measurement, the UE may do the switches in parallel.

TCI state switching delay for s-DCI in the case of overlapping or adjacent SSBs would become: T_{HARQ}+3Nₛₗₒₜ^{subframe,μ}+ (TOₖ₁*(T_{first-SSB1}+T_{SSB-proc})+T_{L1-RSRP2}+TOᵤₖ₂*(T_{first-SSB2}+T_{SSB-proc}))/NR slot length, where TOₖ₁ and T_{first-SSB}1 are associated to the known TCI state and T_{L1-RSRP2}, TOᵤₖ₂ and T_{first-SSB2} are associated to the unknown TCI state, T_{first-SSB1} is time to first SSB transmission after MAC CE command is decoded by the UE, and T_{first-SSB2} is time to first SSB transmission after L1-RSRP measurement (after T_{L1-RSRP2}).

TCI state switching delay for m-DCI in the case of overlapping or adjacent SSBs would become for each TRP-specific MAC-CE (additional SSB periodicity is added for the unknown TCI state): When a MAC CE command indicating a downlink TCI state switch for CORESETPoolIndex p is received at slot n, and if the TCI state is unknown, UE shall be able to receive on the target TCI state at the first slot that is after slot n+T_{HARQ}+3Nₛₗₒₜ^{subframe,μ}+(T_{L1-RSRP}+TOᵤₖ*(T_{first-SSBp}, +T_{SSB-proc})+TO_{K}*T_{SSBp}))/NR slot length, where (1-5)

1. T_{first-SSBp} is time to first SSB transmission (i.e., SSB associated to CORESETPoolIndex p) after L1-RSRP measurement; The SSB shall be the QCL-TypeA or QCL-TypeC to target TCI state.

2. T_{SSB-proc}=2 ms.

3. TOₖ=1 if target TCI state of the known state is not in the active TCI state list for PDSCH/PDCCH, 0 otherwise. TOᵤₖ=1 for CSI-RS based L1-RSRP measurement, and 0 for SSB based L1-RSRP measurement when TCI state switching involves QCL-TypeD, and TOuk=1 when TCI state switching involves other QCL types only.

4. T_{SSBp} is the SSB periodicity.

5. When the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, where the target TCI state for CORESETPoolIndex q is known, and the first SSB transmission SSBₚ for the TCI state activated for CORESETPoolIndex p overlaps or is adjacent to the first SSB transmission SSB_{q} for the TCI state activated for CORESETPoolIndex q after decoding the MAC-CEs

### C. When Both TCI States are Unknown:

For the overlapping or adjacent case, two approaches are possible: The UE performs the TCI state switches in parallel or sequentially. Network visibility of the order of TCI state switches can be improved by performing the TCI state switches sequentially. Here, options 1-4 can be implemented as described.

Parallel would in practice mean that the UE uses every other SSB occasion for each TRP measurement. Sequentially would mean that the UE uses the first X SSB for performing the measurement (and if needed, one synchronization) i.e. one TCI state switch for one of the TRPs, and then uses the next Y SSBs to perform the needed measurement for the other TRP TCI state switch. The total delay is approximately the same, but the difference is that if the TCI state switches are performed sequentially, the network can start scheduling one of the TCI states with a shorter delay. If the TCI state switches are performed in parallel, the network can start scheduling with the new TCI states only after the total delay.

Sequential activation of two TCI states here means that the UE first completes the TCI state switch for one TCI state i.e. performs L1-RSRP measurements and SSB synchronization, and then does the same steps for the other TCI state. UE can be scheduled from the first TCI state when the switch is completed and from both TCI states when both TCI state switches are completed.

Option 1: First complete the TCI state switch for the TCI state that has QCL relationship to the SSB with shorter SSB periodicity (here it makes sense to activate the one with shorter SSB periodicity first, because then the UE can start using one of the TCI states faster).

Option 2: First complete the TCI state switch for the TCI state that has QCL relationship to the SSB that comes first in time after decoding the MAC-CE.

Option 3: First complete the TCI state switch for the TCI state of the anchor link.

Option 4: In m-DCI mode, first complete the TCI state switch for the TCI state for which the TCI state activation MAC-CE is received first.

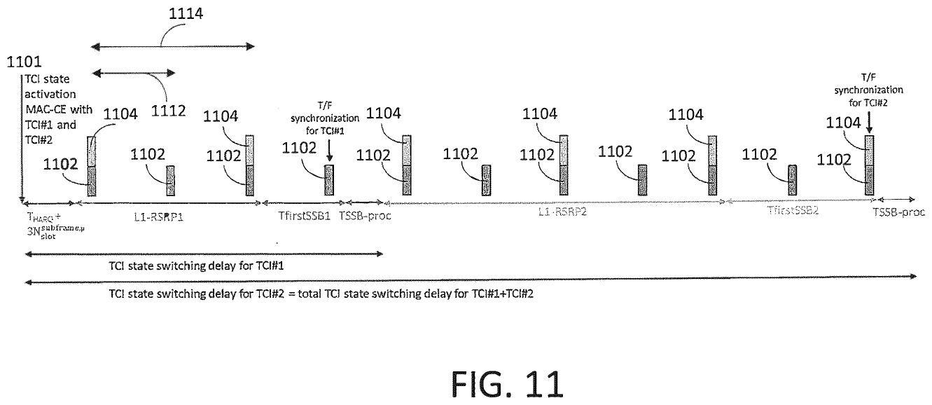

FIG. 11 describes the approach when SSB periodicities are different and SSBs (1102, 1104) are overlapping. TCI #1 is the TCI state that is activated first (can be based on any of the options 1-3). TCI state 1 can be scheduled after the switch is complete. After TCI state switch 2 is completed, the UE can start receiving with both TCI states. For Option 4, the delays would be similar, but two MAC-CEs would be used. In FIG. 11, one MAC-CE 1101 is shown.

Thus, FIG. 11 shows TCI activation of two unknown TCI states and different SSB periodicities. SSB 1102 has periodicity 1112, and SSB 1104 has periodicity 1114.

The equation for s-DCI for options 1-3 for the overlapping/adjacent SSBs case would become: T_{HARQ}+3Nₛₗₒₜ^{subframe,μ}+(T_{L1-RSRP1}+TOᵤₖ₁*(T_{first-SSB1}+T_{SSB-proc})+T_{L1-RSRP2}+TOᵤₖ₂*(T_{first-SSB2}+T_{SSB-proc}))/NR slot length, where T_{L1-RSRP1}, TOᵤₖ₁, and T_{first-SSB1} are related to the TCI state that is to be activated first (Option 1: TCI state with association to SSB with shorter SSB periodicity, Option 2: TCI state with association to SSB that is first in time after processing the MAC-CE, Option 3: TCI state of the anchor TRP) and T_{L1-RSRP2}, TOᵤₖ₂, and T_{first-SSB2} are related to the TCI state that is to be activated second. T_{first-SSB} is time to first SSB transmission after L1-RSRP measurement (after T_{L1-RSRP}).

The equation for m-DCI with option 1, 2, 3 or 4 for the overlapping/adjacent SSB would become: T_{HARQ}+3Nₛₗₒₜ^{subframe,μ}+(T_{L1-RSRPp}+TOᵤₖₚ*(T_{first-SSBp}+T_{SSB-proc})+Toverlap*(T_{L1-RSRPq}+TO_{ukq}*(T_{first-SSBq}+T_{SSB-proc})))/NR slot length, where Toverlap=1 if the UE receives a TCI state switch command for CORESETPoolIndex p while performing TCI state switch of CORESETPoolIndex q, or the UE receives a TCI state switch command for CORESETPoolIndex p and a TCI state switch command for CORESETPoolIndex q at the same slot, and the first SSBₚ for the TCI state activated for CORESETPoolIndex p overlaps or is adjacent to the first SSB_{q} for the TCI state activated for CORESETPoolIndex q after decoding the MAC-CEs, and the L1-RSRP measurement period is SSB based and at least one of Options 1-4 holds true: Option 1: The SSB periodicity of the SSB associated to the TCI state activated for CORESETPoolIndex p is longer than the SSB periodicity of the SSB associated to the TCI state activated for CORESETPoolIndex q, Option 2: SSBp associated to the TCI state activated for CORESETPoolIndex p comes later in time than SSBq associated to the TCI state activated for CORESETPoolIndex q, Option 3: CORESETPoolIndex p is the CORESETPoolIndex of the non-anchor link, Option 4: if MAC CE activating SSBₚ comes later in time than MAC CE activating SSB_{q}. Otherwise, Toverlap=0.

It should also be noted that the description herein concentrated on the case when the number of TCI states is two. However, the high level principles described herein (options 1-4) can apply to any number of activated TCI states larger or equal to two, if multiple TCI states are activated for one or each of the TRPs in the MAC-CEs or if multi-TRP transmission/reception is in the future specified for more than two TRPs and TCI states are activated/indicated for more than two QCL Type D sources. It is also noted that the different Options listed above can be used in combination. For example, the UE may synchronize with SSB with longer or shorter periodicity first if SSB periodicities are different (Option 1), and if SSB periodicities are the same, synchronize first with SSB of the anchor link (Option 3).

The same principle may also apply to other similar requirements as TCI state switching delay requirements, such as LTM cell switch delay requirement, where the cell switch command indicates currently a single target TCI state. If in the future LTM cell switch command may indicate more TCI states (if cell switch to multi-TRP transmission is enabled) and the UE needs to synchronize with reference signals associated to these TCI states, the delay may be defined using a similar principle as described herein.

For s-DCI, two TCI states for the two TRPs are placed at the same codepoint on the active TCI state list with one MAC-CE. DCI points at a codepoint on the list, so a single DCI indicates a pair of TCI states in one codepoint. For m-DCI, there are separate active TCI state lists for each TRP, and hence there is only one TCI state on each codepoint, activated by one MAC-CE. In this case separate DCIs are used to indicate a TCI state at one codepoint on each list.

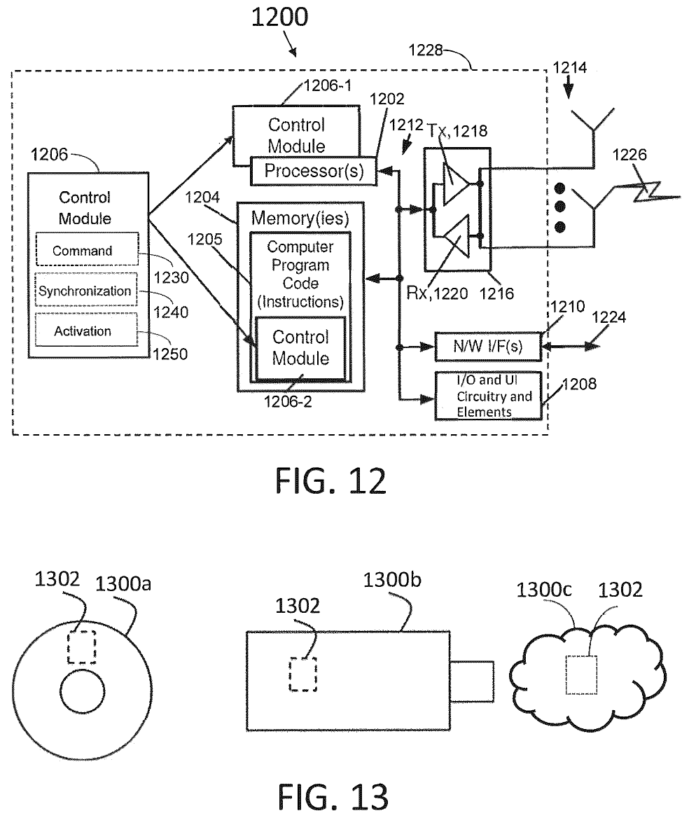

FIG. 12 is an example apparatus 1200, which may be implemented in hardware, configured to implement the examples described herein. The apparatus 1200 comprises at least one processor 1202 (e.g. an FPGA and/or CPU), one or more memories 1204 including computer program code 1205, the computer program code 1205 having instructions to carry out the methods described herein, wherein the at least one memory 1204 and the computer program code 1205 are configured to, with the at least one processor 1202, cause the apparatus 1200 to implement circuitry, a process, component, module, or function (implemented with control module 1206) to implement the examples described herein. The memory 1204 may be a non-transitory memory, a transitory memory, a volatile memory (e.g. RAM), or a non-volatile memory (e.g. ROM).

Optionally included command 1230 may implement transmission or reception of one or more MAC control elements as described herein. Optionally included synchronization 1240 may implement synchronization of one or more TCI states as described herein. Optionally included activation 1250 may implement activation of a TCI state as described herein.

The apparatus 1200 includes a display and/or I/O interface 1208, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1200 includes one or more communication e.g. network (N/W) interfaces (I/F(s)) 1210. The communication I/F(s) 1210 may be wired and/or wireless and communicate over the Internet/other network(s) via any communication technique including via one or more links 1224. The link(s) 1224 may be the link(s) 131 and/or 176 from FIG. 1. The link(s) 131 and/or 176 from FIG. 1 may also be implemented using transceiver(s) 1216 and corresponding wireless link(s) 1226. The communication I/F(s) 1210 may comprise one or more transmitters or one or more receivers.

The transceiver 1216 comprises one or more transmitters 1218 and one or more receivers 1220. The transceiver 1216 and/or communication I/F(s) 1210 may comprise standard well-known components such as an amplifier, filter, frequency-converter, (de) modulator, and encoder/decoder circuitries and one or more antennas, such as antennas 1214 used for communication over wireless link 1226.

The control module 1206 of the apparatus 1200 comprises one of or both parts 1206-1 and/or 1206-2, which may be implemented in a number of ways. The control module 1206 may be implemented in hardware as control module 1206-1, such as being implemented as part of the one or more processors 1202. The control module 1206-1 may be implemented also as an integrated circuit or through other hardware such as a programmable gate array. In another example, the control module 1206 may be implemented as control module 1206-2, which is implemented as computer program code (having corresponding instructions) 1205 and is executed by the one or more processors 1202. For instance, the one or more memories 1204 store instructions that, when executed by the one or more processors 1202, cause the apparatus 1200 to perform one or more of the operations as described herein. Furthermore, the one or more processors 1202, the one or more memories 1204, and example algorithms (e.g., as flowcharts and/or signaling diagrams), encoded as instructions, programs, or code, are means for causing performance of the operations described herein.

The apparatus 1200 to implement the functionality of control 1206 may be UE 110, RAN node 170 (e.g. gNB), or network element(s) 190 (e.g. LMF 190). Thus, processor 1202 may correspond to processor(s) 120, processor(s) 152 and/or processor(s) 175, memory 1204 may correspond to one or more memories 125, one or more memories 155 and/or one or more memories 171, computer program code 1205 may correspond to computer program code 123, computer program code 153, and/or computer program code 173, control module 1206 may correspond to module 140-1, module 140-2, module 150-1, and/or module 150-2, and communication I/F(s) 1210 and/or transceiver 1216 may correspond to transceiver 130, antenna(s) 128, transceiver 160, antenna(s) 158, N/W I/F(s) 161, and/or N/W I/F(s) 180. Alternatively, apparatus 1200 and its elements may not correspond to either of UE 110, RAN node 170, or network element(s) 190 and their respective elements, as apparatus 1200 may be part of a self-organizing/optimizing network (SON) node or other node, such as a node in a cloud.

Apparatus 1200 may also correspond to TRP 1 170-1 or TRP 2 170-2. TRP 1 170-1 or TRP 2 170-2 may be configured similar to RAN node 170 or one or more network elements 190.

The apparatus 1200 may also be distributed throughout the network (e.g. 100) including within and between apparatus 1200 and any network element (such as a network control element (NCE) 190 and/or the RAN node 170 and/or UE 110).

Interface 1212 enables data communication and signaling between the various items of apparatus 1200, as shown in FIG. 12. For example, the interface 1212 may be one or more buses such as address, data, or control buses, and may include any interconnection mechanism, such as a series of lines on a motherboard or integrated circuit, fiber optics or other optical communication equipment, and the like. Computer program code (e.g. instructions) 1205, including control 1206 may comprise object-oriented software configured to pass data or messages between objects within computer program code 1205. The apparatus 1200 need not comprise each of the features mentioned, or may comprise other features as well. The various components of apparatus 1200 may at least partially reside in a common housing 1228, or a subset of the various components of apparatus 1200 may at least partially be located in different housings, which different housings may include housing 1228.

FIG. 13 shows a schematic representation of non-volatile memory media 1300a (e.g. computer/compact disc (CD) or digital versatile disc (DVD)) and 1300b (e.g. universal serial bus (USB) memory stick) and 1300c (e.g. cloud storage for downloading instructions and/or parameters 1302 or receiving emailed instructions and/or parameters 1302) storing instructions and/or parameters 1302 which when executed by a processor allows the processor to perform one or more of the steps of the methods described herein. Instructions and/or parameters 1302 may represent a non-transitory computer readable medium.

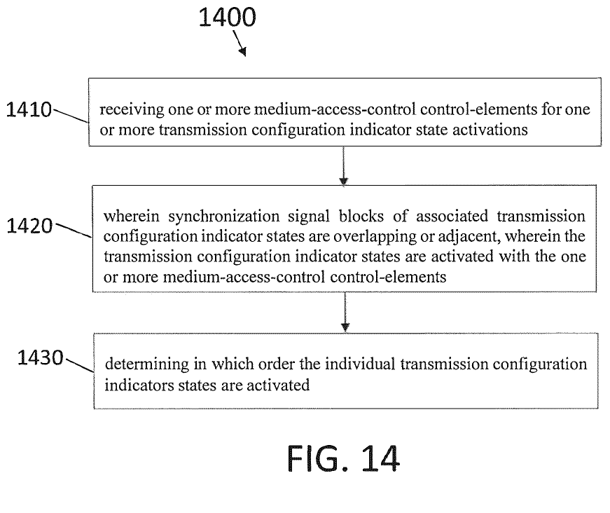

FIG. 14 is an example method 1400, based on the example embodiments described herein. At 1410, the method includes receiving one or more medium-access-control control-elements for one or more transmission configuration indicator state activations. At 1420, the method includes wherein synchronization signal blocks of associated transmission configuration indicator states are overlapping or adjacent, wherein the transmission configuration indicator states are activated with the one or more medium-access-control control-elements. At 1430, the method includes determining in which order the individual transmission configuration indicators states are activated. Method 1400 may be performed with UE 110 or apparatus 1200.

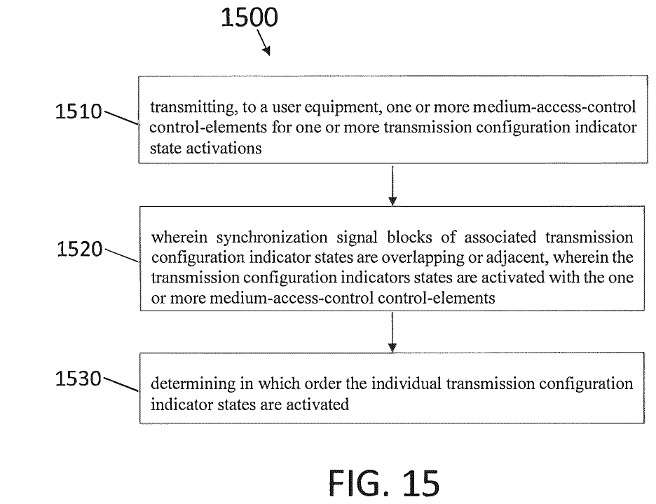

FIG. 15 is an example method 1500, based on the example embodiments described herein. At 1510, the method includes transmitting, to a user equipment, one or more medium-access-control control-elements for one or more transmission configuration indicator state activations. At 1520, the method includes wherein synchronization signal blocks of associated transmission configuration indicator states are overlapping or adjacent, wherein the transmission configuration indicators states are activated with the one or more medium-access-control control-elements. At 1530, the method includes determining in which order the individual transmission configuration indicator states are activated. Method 1500 may be performed with RAN node 170, one or more network elements 190, or apparatus 1200.

The following examples are provided and described herein.

Example 1. An apparatus including: at least one processor; and at least one memory storing instructions that, when executed by the at least one processor, cause the apparatus at least to: receive one or more medium-access-control control-elements for one or more transmission configuration indicator state activations; wherein synchronization signal blocks of associated transmission configuration indicator states are overlapping or adjacent, wherein the transmission configuration indicator states are activated with the one or more medium-access-control control-elements; and determine in which order the individual transmission configuration indicators states are activated.

Example 2. The apparatus of example 1, wherein the determining of the order comprises: determining a transmission configuration indicator state to activate first, based on a periodicity of a synchronization signal block associated to the transmission configuration indicator state and/or a status of the transmission configuration indicator state.

Example 3. The apparatus of example 2, wherein when determining the transmission configuration indicator state to activate first, the instructions, when executed by the at least one processor, cause the apparatus at least to: determine to activate a first transmission configuration indicator state first, in response to a periodicity of a first synchronization signal block associated to the first transmission configuration indicator state being longer than a periodicity of a second synchronization signal block associated to a second transmission configuration indicator state.

Example 4. The apparatus of example 3, wherein the first transmission configuration indicator state is known and the second transmission configuration indicator state is known.

Example 5. The apparatus of any of examples 2 to 4, wherein when determining the transmission configuration indicator state to activate first, the instructions, when executed by the at least one processor, cause the apparatus at least to: determine to activate a first transmission configuration indicator state first, in response to a periodicity of a first synchronization signal block associated to the first transmission configuration indicator state being shorter than a periodicity of a second synchronization signal block associated to a second transmission configuration indicator state.

Example 6. The apparatus of example 5, wherein the first transmission configuration indicator state is unknown and the second transmission configuration indicator state is unknown.

Example 7. The apparatus of any of examples 1 to 6, wherein the determining of the order comprises: determining to activate first a transmission configuration indicator state that is associated with a synchronization signal block that comes first in time after decoding the one or more medium-access-control control-elements.

Example 8. The apparatus of example 7, wherein the synchronization signal block associated with the transmission configuration indicator state that is activated first is adjacent to another synchronization signal block associated with another transmission configuration indicator state that is not activated first.

Example 9. The apparatus of any of examples 1 to 8, wherein the determining of the order comprises: determining to activate first a transmission configuration indicator state of an anchor link.

Example 10. The apparatus of example 9, wherein the anchor link is based on one of the following: a transmission configuration indicator state that comes from a transmission reception point with a physical downlink control channel transmission configuration indicator state, in case a physical downlink control channel is transmitted by a single transmission reception point associated with single downlink control information, or a transmission configuration indicator state that comes from a transmission reception point with an uplink transmission configuration indicator state, in case a physical uplink shared channel or a physical uplink control channel is transmitted to a single transmission reception point, or an anchor transmission reception point being configured by a network.

Example 11. The apparatus of any of examples 1 to 10, wherein the determining of the order comprises: determining to activate first a transmission configuration indicator state associated with a medium-access-control control-element that arrived first in time, in response to a plurality of medium-access-control control-elements being received with the apparatus.

Example 12. The apparatus of any of examples 1 to 11, wherein the determining of the order comprises: determining to activate first a first transmission configuration indicator state that is known rather than a second transmission configuration indicator state that is unknown.

Example 13. The apparatus of any of examples 1 to 12, wherein the determining of the order comprises: determining to activate a transmission configuration indicator state first, wherein the activating the transmission configuration indicator state first comprises using a synchronization signal block associated to the firstly activated transmission configuration indicator state on one or more first overlapping or adjacent synchronization signal block occasions without waiting for activation of another transmission configuration indicator state.

Example 14. The apparatus of any of examples 1 to 13, wherein one of the transmission configuration indicator states is activated based on a decoding of the one or more medium-access-control control-elements.

Example 15. The apparatus of example 14, wherein the activating the transmission configuration indicator state comprises performing time or frequency synchronization with a first synchronization signal block and synchronization signal block processing.

Example 16. The apparatus of example 15, wherein the transmission configuration indicator state is known.

Example 17. The apparatus of any of examples 15 to 16, wherein the transmission configuration indicator state is unknown, and the activating the transmission configuration indicator state comprises performing a layer 1 reference signal receive power measurement.

Example 18. The apparatus of any of examples 1 to 17, wherein the instructions, when executed by the at least one processor, cause the apparatus at least to: determine a requirement for a transmission configuration indicator state switch delay, based on the synchronization signal blocks of associated transmission configuration indicator states being overlapping or adjacent, in response to receipt of the one or more medium-access-control control-elements.

Example 19. The apparatus of example 18, wherein the order in which the individual transmission configuration indicator states are activated is determined during the transmission configuration indicator state switch delay.

Example 20. The apparatus of any of examples 1 to 19, wherein the apparatus comprises a user equipment.

Example 21. An apparatus including: at least one processor; and at least one memory storing instructions that, when executed by the at least one processor, cause the apparatus at least to: transmit, to a user equipment, one or more medium-access-control control-elements for one or more transmission configuration indicator state activations; wherein synchronization signal blocks of associated transmission configuration indicator states are overlapping or adjacent, wherein the transmission configuration indicators states are activated with the one or more medium-access-control control-elements; and determine in which order the individual transmission configuration indicator states are activated.

Example 22. The apparatus of example 21, wherein the determining of the order comprises: determining that a transmission configuration indicator state is activated first, based on a periodicity of a synchronization signal block associated to the transmission configuration indicator state and/or a status of the transmission configuration indicator state.

Example 23. The apparatus of example 22, wherein the determining that a transmission configuration indicator state is activated first comprises: determining that a first transmission configuration indicator state is activated first, when a periodicity of a first synchronization signal block associated to the first transmission configuration indicator state is longer than a periodicity of a second synchronization signal block associated to a second transmission configuration indicator state.

Example 24. The apparatus of example 23, wherein the first transmission configuration indicator state is known and the second transmission configuration indicator state is known.

Example 25. The apparatus of any of examples 22 to 24, wherein the determining that a transmission configuration indicator state is activated first comprises: determining that a first transmission configuration indicator state is activated first, when a periodicity of a first synchronization signal block associated to the first transmission configuration indicator state is shorter than a periodicity of a second synchronization signal block associated to a second transmission configuration indicator state.

Example 26. The apparatus of example 25, wherein the first transmission configuration indicator state is unknown and the second transmission configuration indicator state is unknown.

Example 27. The apparatus of any of examples 21 to 26, wherein the determining of the order comprises: determining that a transmission configuration indicator state that is associated with a synchronization signal block that comes first in time after a decoding of the one or more medium-access-control control-elements is activated first.

Example 28. The apparatus of example 27, wherein the synchronization signal block associated with the transmission configuration indicator state that is activated first is adjacent to another synchronization signal block associated with another transmission configuration indicator state that is not activated first.

Example 29. The apparatus of any of examples 21 to 28, wherein the determining of the order comprises: determining that a transmission configuration indicator state of an anchor link is activated first.

Example 30. The apparatus of example 29, wherein the anchor link is based on one of the following: a transmission configuration indicator state that comes from a transmission reception point with a physical downlink control channel transmission configuration indicator state, in case a physical downlink control channel is transmitted by a single transmission reception point associated with single downlink control information, or a transmission configuration indicator state that comes from a transmission reception point with an uplink transmission configuration indicator state, in case a physical uplink shared channel or a physical uplink control channel is transmitted to a single transmission reception point, or an anchor transmission reception point being configured by a network.

Example 31. The apparatus of any of examples 21 to 30, wherein the determining of the order comprises: determining that a transmission configuration indicator state associated with a medium-access-control control element that arrived first in time is activated first, when a plurality of medium-access-control control-elements are transmitted with the apparatus.

Example 32. The apparatus of any of examples 21 to 31, wherein the determining of the order comprises: determining that a first transmission configuration indicator state that is known is activated first rather than a second transmission configuration indicator state that is unknown.

Example 33. The apparatus of any of examples 21 to 32, wherein the one or more medium-access-control control-elements causes the user equipment to activate one of the individual transmission configuration indicator states.

Example 34. The apparatus of any of examples 21 to 33, wherein the instructions, when executed by the at least one processor, cause the apparatus at least to: determine a requirement for a transmission configuration indicator state switch delay, based on the synchronization signal blocks of associated transmission configuration indicator states being overlapping or adjacent, in response to transmission of the one or more medium-access-control control-elements.

Example 35. The apparatus of example 34, wherein the order in which the individual transmission configuration indicator states are activated is determined during the transmission configuration indicator state switch delay.

Example 36. The apparatus of any of examples 21 to 35, wherein the apparatus comprises a radio access network node.

Example 37. A method including: receiving one or more medium-access-control control-elements for one or more transmission configuration indicator state activations; wherein synchronization signal blocks of associated transmission configuration indicator states are overlapping or adjacent, wherein the transmission configuration indicator states are activated with the one or more medium-access-control control-elements; and determining in which order the individual transmission configuration indicators states are activated.

Example 38. A method including: transmitting, to a user equipment, one or more medium-access-control control-elements for one or more transmission configuration indicator state activations; wherein synchronization signal blocks of associated transmission configuration indicator states are overlapping or adjacent, wherein the transmission configuration indicators states are activated with the one or more medium-access-control control-elements; and determining in which order the individual transmission configuration indicator states are activated.

Example 39. An apparatus including: means for receiving one or more medium-access-control control-elements for one or more transmission configuration indicator state activations; wherein synchronization signal blocks of associated transmission configuration indicator states are overlapping or adjacent, wherein the transmission configuration indicator states are activated with the one or more medium-access-control control-elements; and means for determining in which order the individual transmission configuration indicators states are activated.

Example 40. An apparatus including: means for transmitting, to a user equipment, one or more medium-access-control control-elements for one or more transmission configuration indicator state activations; wherein synchronization signal blocks of associated transmission configuration indicator states are overlapping or adjacent, wherein the transmission configuration indicators states are activated with the one or more medium-access-control control-elements; and means for determining in which order the individual transmission configuration indicator states are activated.

Example 41. A computer readable medium including instructions stored thereon for performing at least the following: receiving one or more medium-access-control control-elements for one or more transmission configuration indicator state activations; wherein synchronization signal blocks of associated transmission configuration indicator states are overlapping or adjacent, wherein the transmission configuration indicator states are activated with the one or more medium-access-control control-elements; and determining in which order the individual transmission configuration indicators states are activated.

Example 42. A computer readable medium including instructions stored thereon for performing at least the following: transmitting, to a user equipment, one or more medium-access-control control-elements for one or more transmission configuration indicator state activations; wherein synchronization signal blocks of associated transmission configuration indicator states are overlapping or adjacent, wherein the transmission configuration indicators states are activated with the one or more medium-access-control control-elements; and determining in which order the individual transmission configuration indicator states are activated.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):
3GPP third generation partnership project
4G fourth generation
5G fifth generation
5GC 5G core network
ACK acknowledgement
AMF access and mobility management function
ASIC application-specific integrated circuit
CD compact/computer disc
CORESET control resource set
CPU central processing unit
CSI-RS channel state information reference signal
CU central unit or centralized unit
DCI downlink control information
DL downlink
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved UMTS terrestrial radio access, i.e., the LTE radio access technology
E-UTRAN E-UTRA network
F1 interface between the CU and the DU
FPGA field-programmable gate array
FR frequency range (e.g. FR2)
gNB base station for 5G/NR, i.e., a node providing NR user plane and control plane protocol terminations towards the UE, and connected via the NG interface to the 5GC
HARQ hybrid automatic repeat request
k known (e.g. TOᵤₖ)
IAB integrated access and backhaul
I/F interface
I/O input/output
L1 layer 1
LMF location management function
LTE long term evolution (4G)
LTM lower layer triggered mobility
μ subcarrier spacing used by the network (μ=0 is for 15 kHz, μ=1 is for 30 kHz)
MAC medium access control
MAC-CE medium access control control element
m-DCI multi-DCI, multiple downlink control information
MIMO multiple input multiple output
MME mobility management entity
MRO mobility robustness optimization
NCE network control element
ng or NG new generation
ng-eNB new generation eNB
NG-RAN new generation radio access network
NR new radio
N/W network
PDA personal digital assistant
PDCCH physical downlink control channel
PDCP packet data convergence protocol
PDSCH physical downlink shared channel
PHY physical layer
proc processing
PUCCH physical uplink control channel
PUSCH physical uplink shared channel
PUxCH PUCCH or PUSCH
QCL quasi co-location
RAM random access memory
RAN radio access network
RAN4 RAN working group 4
Rel release
RLC radio link control
ROM read-only memory
RRC radio resource control
RSRP reference signal received power
RU radio unit
Rx receive, or receiver, or reception
SDAP service data adaptation protocol
s-DCI single-DCI, single downlink control information
SGW serving gateway
SMF session management function
SON self-organizing/optimizing network
SRS sounding reference signal
SSB synchronization signal block
T time
TCI transmission configuration indicator
T/F time/frequency
TO timing offset
TRP transmission reception point
TS technical specification
Tx transmit, or transmitter, or transmission
Type A Doppler shift, Doppler spread, average delay, delay spread
Type C Doppler shift, average delay
Type D spatial Rx parameter
u unknown (e.g. TOᵤₖ)
UAV unmanned aerial vehicle
UE user equipment (e.g., a wireless, typically mobile device)
UI user interface
UL uplink
UMTS Universal Mobile Telecommunications System
UPF user plane function
USB universal serial bus
UTRAN UMTS terrestrial radio access network
WI work item
X2 network interface between RAN nodes and between RAN and the core network
Xn network interface between NG-RAN nodes

What is claimed is:

1. An apparatus, comprising:
at least one processor; and
at least one memory storing instructions that, when executed by the at least one processor, cause the apparatus at least to:
receive one or more medium-access-control control-elements for one or more transmission configuration indicator state activations,
wherein synchronization signal blocks of associated transmission configuration indicator states are overlapping or adjacent, and wherein the transmission configuration indicator states are activated with the one or more medium-access-control control-elements; and
determine in which order the individual transmission configuration indicators states are activated.

2. The apparatus of claim 1, wherein the determining of the order comprises:
determining a transmission configuration indicator state to activate first, based on a periodicity of a synchronization signal block associated to the transmission configuration indicator state and/or a status of the transmission configuration indicator state.

3. The apparatus of claim 2, wherein when determining the transmission configuration indicator state to activate first, the instructions, when executed by the at least one processor, cause the apparatus at least to:
determine to activate a first transmission configuration indicator state first, in response to a periodicity of a first synchronization signal block associated to the first transmission configuration indicator state being longer than a periodicity of a second synchronization signal block associated to a second transmission configuration indicator state.

4. The apparatus of claim 3, wherein the first transmission configuration indicator state is known and the second transmission configuration indicator state is known.

5. The apparatus of claim 1, wherein the determining of the order comprises:
determining to activate first a transmission configuration indicator state that is associated with a synchronization signal block that comes first in time after decoding the one or more medium-access-control control-elements.

6. The apparatus of claim 5, wherein the synchronization signal block associated with the transmission configuration indicator state that is activated first is adjacent to another synchronization signal block associated with another transmission configuration indicator state that is not activated first.

7. The apparatus of claim 1, wherein the determining of the order comprises:
determining to activate first a first transmission configuration indicator state that is known rather than a second transmission configuration indicator state that is unknown.

8. The apparatus of claim 1, wherein one of the transmission configuration indicator states is activated based on a decoding of the one or more medium-access-control control-elements.

9. The apparatus of claim 1, wherein the instructions, when executed by the at least one processor, cause the apparatus at least to:
determine a requirement for a transmission configuration indicator state switch delay, based on the synchronization signal blocks of associated transmission configuration indicator states being overlapping or adjacent, in response to receipt of the one or more medium-access-control control-elements.

10. The apparatus of claim 9, wherein the order in which the individual transmission configuration indicator states are activated is determined during the transmission configuration indicator state switch delay.

11. An apparatus, comprising:
at least one processor; and
at least one memory storing instructions that, when executed by the at least one processor, cause the apparatus at least to:
transmit, to a user equipment, one or more medium-access-control control-elements for one or more transmission configuration indicator state activations,
wherein synchronization signal blocks of associated transmission configuration indicator states are overlapping or adjacent, and wherein the transmission configuration indicators states are activated with the one or more medium-access-control control-elements; and
determine in which order the individual transmission configuration indicator states are activated.

12. The apparatus of claim 11, wherein the determining of the order comprises:
determining that a transmission configuration indicator state is activated first, based on a periodicity of a synchronization signal block associated to the transmission configuration indicator state and/or a status of the transmission configuration indicator state.

13. The apparatus of claim 12, wherein the determining that a transmission configuration indicator state is activated first comprises:
determining that a first transmission configuration indicator state is activated first, when a periodicity of a first synchronization signal block associated to the first transmission configuration indicator state is longer than a periodicity of a second synchronization signal block associated to a second transmission configuration indicator state.

14. The apparatus of claim 13, wherein the first transmission configuration indicator state is known and the second transmission configuration indicator state is known.

15. The apparatus of claim 11, wherein the determining of the order comprises:
determining that a transmission configuration indicator state that is associated with a synchronization signal block that comes first in time after a decoding of the one or more medium-access-control control-elements is activated first.

16. The apparatus of claim 15, wherein the synchronization signal block associated with the transmission configuration indicator state that is activated first is adjacent to another synchronization signal block associated with another transmission configuration indicator state that is not activated first.

17. The apparatus of claim 11, wherein the determining of the order comprises:
determining that a first transmission configuration indicator state that is known is activated first rather than a second transmission configuration indicator state that is unknown.

18. The apparatus of claim 11, wherein the one or more medium-access-control control-elements causes the user equipment to activate one of the individual transmission configuration indicator states.

19. The apparatus of claim 11, wherein the instructions, when executed by the at least one processor, cause the apparatus at least to:
determine a requirement for a transmission configuration indicator state switch delay, based on the synchronization signal blocks of associated transmission configuration indicator states being overlapping or adjacent, in response to transmission of the one or more medium-access-control control-elements.

20. The apparatus of claim 19, wherein the order in which the individual transmission configuration indicator states are activated is determined during the transmission configuration indicator state switch delay.

21. A method, comprising:
receiving one or more medium-access-control control-elements for one or more transmission configuration indicator state activations,
wherein synchronization signal blocks of associated transmission configuration indicator states are overlapping or adjacent, and wherein the transmission configuration indicator states are activated with the one or more medium-access-control control-elements; and
determining in which order the individual transmission configuration indicators states are activated.

22. A method, comprising:
transmitting, to a user equipment, one or more medium-access-control control-elements for one or more transmission configuration indicator state activations,
wherein synchronization signal blocks of associated transmission configuration indicator states are overlapping or adjacent, and wherein the transmission configuration indicators states are activated with the one or more medium-access-control control-elements; and
determining in which order the individual transmission configuration indicator states are activated.

23. A non-transitory computer readable medium comprising instructions stored thereon for performing at least the following:
receiving one or more medium-access-control control-elements for one or more transmission configuration indicator state activations,
wherein synchronization signal blocks of associated transmission configuration indicator states are overlapping or adjacent, and wherein the transmission configuration indicator states are activated with the one or more medium-access-control control-elements; and
determining in which order the individual transmission configuration indicators states are activated.

24. A non-transitory computer readable medium comprising instructions stored thereon for performing at least the following:
transmitting, to a user equipment, one or more medium-access-control control-elements for one or more transmission configuration indicator state activations,
wherein synchronization signal blocks of associated transmission configuration indicator states are overlapping or adjacent, and wherein the transmission configuration indicators states are activated with the one or more medium-access-control control-elements; and
determining in which order the individual transmission configuration indicator states are activated.
